(19) United States
(12) Patent Application Publication
(10) Pub. No.: US 2011/0107109 A1
(43) Pub. Date: May 5, 2011

(54) STORAGE SYSTEM AND METHOD FOR MANAGING DATA SECURITY THEREOF

(75) Inventors: YANG-YUAN CHEN, Tu-Cheng (TW); MING-CHIH HSIEH, Tu-Cheng (TW)

(73) Assignee: HON HAI PRECISION INDUSTRY CO., LTD., Tu-Cheng (TW)

(21) Appl. No.: 12/842,040

(22) Filed: Jul. 23, 2010

(30) Foreign Application Priority Data
Oct. 30, 2009 (CN) 200910309098.8

(51) Int. Cl. G06F 12/14

(52) U.S. Cl. 713/189

(57) ABSTRACT

A method for managing data security of a storage system includes dividing a storage unit of the storage system into a data access block and a key block. An encryption key input is used to set the encryption key, the data access block is encrypted using the set encryption key, and the set encryption key is stored in the key block. The data access block may be decrypted using the decryption key under the condition that the decryption key corresponds to the set encryption key.

### BACKGROUND

1. Field of the Disclosure

Embodiments of the present disclosure relate to data security management, and particularly to a storage system and a method for managing data security of the storage system.

2. Description of Related Art

A storage device, such as a hard disk drive, a random access memory, a read only memory, a cache system, or a combination of the aforementioned hardware, is mainly used to store data. However, if such a storage device cannot provide security management of data stored in the storage device, private data can be accessed by anyone.

### BRIEF DESCRIPTION OF THE DRAWINGS

FIG. 1 is a block diagram of one embodiment of a storage system in communication with an electronic device.

FIG. 2 is a block diagram of one embodiment of the data security management unit in the FIG. 1.

FIG. 3 is a schematic diagram illustrating a storage unit of FIG. 1.

FIG. 4 is a flowchart of one embodiment of a method for managing data security of a storage system.

### DETAILED DESCRIPTION

All of the processes described below may be embodied in, and fully automated via, functional code modules executed by one or more general purpose computers or processors. The code modules may be stored in any type of computer-readable medium or other computer storage device. Some or all of the methods may alternatively be embodied in specialized computer hardware.

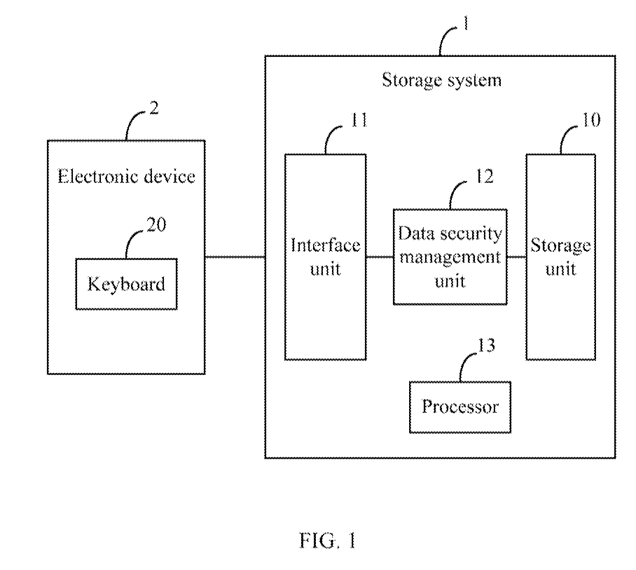

FIG. 1 is a block diagram of one embodiment of a storage system 1 in communication with an electronic device 2. In one embodiment, the storage system 1 includes a storage unit 10, an interface unit 11, and a data security management unit 12. The data security management unit 12 can set an encryption key and a decryption key, encrypt data stored in the storage unit 10, and then decrypt the data stored in the storage unit 10 under the condition that an input decryption key of a user is the same as the set decryption key. By utilizing the data security management unit 12, an identity of the user needs to be verified by inputting of the correct decryption key before the user can access the data stored in the storage unit 10.

The storage unit 10 may store various kinds of data, such as images and videos, for example. The storage system 1 communicates with the electronic device 2 via the interface unit 11. In some embodiments, the interface unit 11 may be a wireless interface unit or a hardwired interface unit. The wireless interface unit may be a BLUETOOTH interface unit, for example. The hardwired interface unit may be a SATA (serial advanced technology attachment) interface unit, or a IDE (Integrated-Drive-Electronics) interface unit, for example.

The storage system 1 also includes a processor 13. The processor 13 executes one or more computerized operations of the storage system 1 and other applications, to provide functions of the storage system 1.

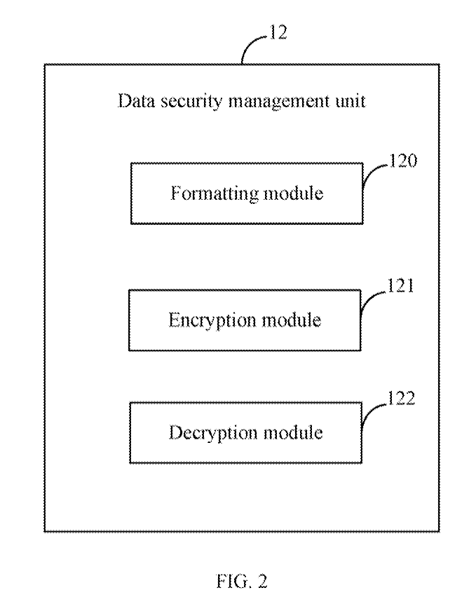

FIG. 2 is a block diagram of one embodiment of the data security management unit 12 in the FIG. 1. In one embodiment, the data security management unit 12 includes a formatting module 120, an encryption module 121, and a decryption module 122. The modules 120, 121, and 122 may comprise one or more computerized codes to be executed by the processor 13 to perform one or more operations of the data security management unit 12.

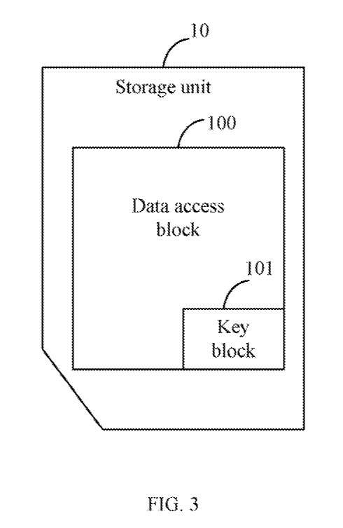

The formatting module 120 divides the storage unit 10 into a plurality of data blocks. In some embodiments, as shown in FIG. 3, the storage unit 10 has been divided into a data access block 100 and a key block 101. The data access block 100 is used to store data, and the key block 101 is used to store an encryption key and a corresponding decryption key. The encryption key is used to encrypt the data in the data access block 100, and the decryption key is used to decrypt the data in the data access block 100. The encryption key and the decryption key may be preset by the user according to user input through a keyboard 20 of the electronic device 2. The keyboard 20 may be a hardware keyboard or a touch panel. Detailed descriptions of the encryption key and the decryption key are provided below.

The encryption module 121 receives the encryption key input by a user though the keyboard 20. Specifically, the encryption module 121 receives a first encryption key input and a second encryption key input by the user, and under the condition that the first encryption key input is the same as the second encryption key input, the encryption module 121 sets the encryption key to match the two inputs.

The encryption module 121 encrypts the data in the data access block 100 using the set encryption key, and stores the set encryption key in the key block 101. In some embodiments, the encryption key may be a symmetric key or an asymmetric key. If the encryption key is symmetric, the encryption key is the same as a corresponding decryption key. If the encryption key is asymmetric, the asymmetric key may include a secret private key and a published public key, and the encryption module 121 encrypts the data in the data access block 100 using the published public key.

The decryption module 122 receives a decryption key input by the user through the keyboard 20, then determines whether the decryption key is valid. In one embodiment, if the encryption key is symmetric, the decryption module 122 determines that the decryption key is valid if the decryption key is the same as the encryption key. If the encryption key is asymmetric, the decryption module 122 determines that the decryption key is valid if the decryption key is the same as the secret private key.

The decryption module 122 decrypts the data access block 100 using the decryption key if the decryption key is valid.

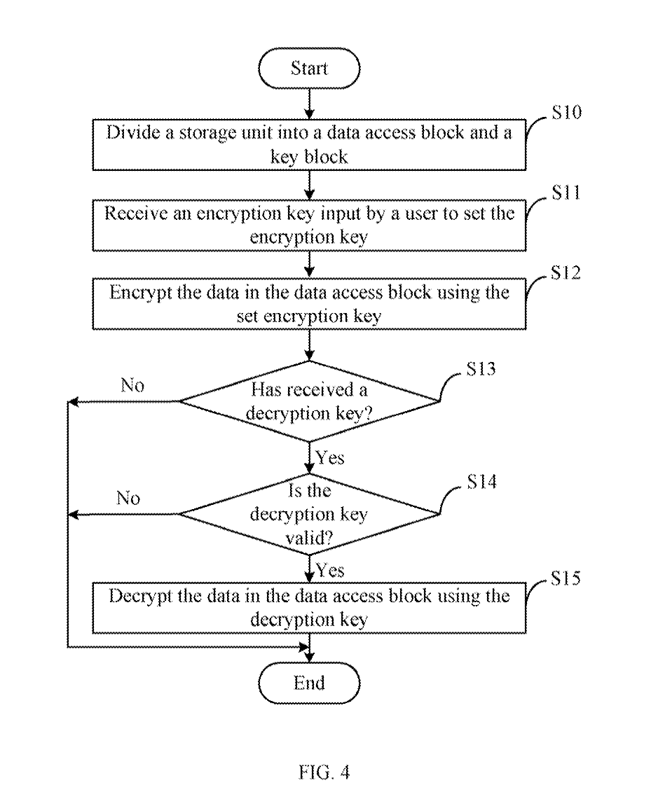

FIG. 4 is a flowchart of one embodiment of a method for managing data security of a storage system.

In block S10, the formatting module 120 divides the storage unit 10 into a data access block 100 and a key block 101.

In block S11, the encryption module 121 receives an encryption key input by a user though the keyboard 20. The encryption module 121 receives a first encryption key input and a second encryption key input entered by the user. If the first encryption key input is the same as the second encryption key input, the encryption module 121 sets the encryption key to match the two inputs.

In block S12, the encryption module 121 encrypts the data in the data access block 100 using the set encryption key, and stores the set encryption key in the key block 101. The encryption key may be symmetric or asymmetric. If the set encryption key is symmetric, the set encryption key is the same as a corresponding decryption key. If the set encryption key is asymmetric, the asymmetric key includes a secret private key and a published public key, the data access block 100 is encrypted using the published public key.

In block S14, the decryption module 122 receives a decryption key input by the user through the keyboard 20.

In block S15, the decryption module 122 determines whether the decryption key input by the user is valid. If the encryption key is symmetric, the decryption module 122 determines that the decryption key is valid if the decryption key is the same as the set encryption key. If the set encryption key is asymmetric, the decryption module 122 determines that the decryption key is valid if the decryption key is the same as the secret private key.

In block S16, the decryption module 122 decrypts the data in the data access block 100 using the decryption key if the decryption key is valid.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A storage system, comprising:
a storage unit to store data;
at least one processor; and
a data security management unit and being executable by the at least one processor, the data security management unit comprising:
a formatting module operable to divide the storage unit into a data access block and a key block;
an encryption module operable to receive an encryption key input by a user to set the encryption key, encrypt the data in the data access block using the set encryption key, and store the set encryption key in the key block;
a decryption module operable to receive a decryption key input by the user, decrypt the data access block using the decryption key under the condition that the decryption key is the same as the set encryption key.

2. The storage system of claim 1, wherein the encryption key is symmetric or asymmetric.

3. The storage system of claim 2, if the encryption key is symmetric, the decryption module determines that the decryption key is valid if the decryption key input by the user is the same as the set encryption key.

4. The storage system of claim 2, if the encryption key is asymmetric, the encryption module receives a secret private key and a published public key input by the user, and encrypts the data access block using the published public key, and the decryption module determines that the decryption key is valid under the condition that the decryption key input by the user is the same as the secret private key.

5. A method for managing data security of a storage system, the method comprising:
dividing a storage unit of the storage system into a data access block and a key block;
receiving an encryption key input by a user to set the encryption key;
encrypting the data access block using the set encryption key;
storing the set encryption key in the key block;
receiving a decryption key input by the user;
decrypting the data access block using the decryption key under the condition that the decryption key is the same as the set encryption key.

6. The method of claim 5, wherein the encryption key is symmetric or asymmetric.

7. The method of claim 6, if the encryption key is symmetric, the decryption key is valid if the decryption key input by the user is the same as the set encryption key.

8. The method of claim 6, if the encryption key is asymmetric, the encrypting key comprises a secret private key and a published public key input by the user, the published public key is used to encrypt the data access block, the secret private key is used to decrypt the data access block under the condition that the decryption key input by the user is the same as the secret private key.

9. A storage medium having stored thereon instructions that, when executed by a processor, cause the processor to perform a method for managing data security of a storage system, the method comprising:
dividing a storage unit of the storage system into a data access block and a key block;
receiving an encryption key input by a user to set the encryption key;
encrypting the data access block using the set encryption key;
storing the set encryption key in the key block;
receiving a decryption key input by the user;
decrypting the data access block using the decryption key under the condition that the decryption key is with the same as the set encryption key.

10. The medium of claim 9, wherein the encryption key is symmetric or asymmetric.

11. The medium of claim 10, if the encryption key is symmetric, the decryption key is valid if the decryption key input by the user is the same as the set encryption key.

12. The medium of claim 10, if the encryption key is asymmetric, the encrypting key comprises a secret private key and a published public key input by the user, the published public key is used to encrypt the data access block, the secret private key is used to decrypt the data access block under the condition that the decryption key input by the user is the same as the secret private key.
